(19) United States
(12) Patent Application Publication
(10) Pub. No.: US 2009/0263652 A1
(43) Pub. Date: Oct. 22, 2009

(54) HYDROPHILIC ADHESIVE COVER FOR COVERING FLUIDIC DEVICES

(75) Inventor: Michael Brauner, Burstadt (DE)

Correspondence Address: DINSMORE & SHOHL, LLP;ONE DAYTON CENTRE, ONE SOUTH MAIN STREET, SUITE 1300, DAYTON, OH, 45402, US

(73) Assignee: ROCHE DIAGNOSTICS OPERATIONS, INC., Indianapolis, IN (US)

(21) Appl. No.: 12/424,079

(22) Filed: Apr. 15, 2009

(30) Foreign Application Priority Data
Apr. 18, 2008 (EP) EP08007656.5

(51) Int. Cl. C09J 7/02

(52) U.S. Cl. 428/339; 428/355 AC

(57) ABSTRACT

Embodiments of the present invention concerning an adhesive mixture having an acrylic adhesive and a detergent, an adhesive foil provided with the adhesive mixture, and a test element provided with the adhesive foil are disclosed. The adhesive mixture combines two properties, i.e. hydrophilicity and adhesiveness with one another, thereby making the adhesive mixture suitable for adhesive foils that are used as covers for fluidic devices.

### CROSS REFERENCE TO RELATED APPLICATIONS

This application claims priority to EP 08007656.5 filed Apr. 18, 2008.

### FIELD OF THE INVENTION

The present invention concerns coverings for fluidic devices, and in particular a hydrophilic adhesive cover for covering fluidic devices.

### BACKGROUND OF THE INVENTION

Test elements are often used in diagnostics and in particular in medical diagnostics. Test elements can for example be used to detect or qualitatively or quantitatively determine various parameters such as glucose, cholesterol, proteins, ketones, phenylalanine or enzymes in biological fluids such as blood, saliva or urine. With such test elements or systems a basic distinction is made between two classes i.e. analytical systems which use wet reagents and systems which use dry reagents. Analytical systems or test elements with dry reagents especially in the form of test carriers e.g. test strips or in the form of disk-shaped test carriers are provided in the field of medical diagnostics. In the test elements the sample usually migrates from an application site to a reaction or detection site. The sample can be transported by means of external forces, for example by means of centrifugal forces or by means of capillary forces. The advantage of transport by means of capillary forces is that the sample migrates “automatically” from the application site to the desired site of further processing without requiring further outside measures.

However, the channels provided in the test elements must be appropriately designed for this in order to allow a migration of the sample liquid, which is usually an aqueous liquid, within the test element. However, the conventional materials from which test elements are constructed are often not sufficiently hydrophilic to enable a capillary flow of aqueous liquids.

Test elements such as fluidic test elements are usually composed of several layers which are joined to one another. The multilayer structure enables the desired structures to be provided in the test element. Various methods can be used to join the individual layers or to cover the test elements such as for example ultrasonic welding, heat sealing processes or joining and/or covering by means of an adhesive foil.

The high costs for equipment and tools are disadvantageous for ultrasonic welding. Furthermore, there is no flexibility in the case of design changes but rather a new sonotrode must be manufactured when the design is changed. In addition, a hydrophilization of the element or cover is required.

Laser welding also results in high equipment costs and also in this case a universal adaptation is not easily possible when the design of the fluidic test element is changed. On the contrary the mask for the cover has to be changed in the case of a design change of the device. Also, in the case of laser welding, it is necessary to hydrophilize the test element or of the cover.

The associated exposure of the reagents present in the test element to heat is a disadvantage in the heat sealing process. For this reason the process can only be used at all for thermostable reagents. A hydrophilization of the test element or of the cover is also necessary with this process.

Additionally, conventional adhesives which glue well are usually very hydrophobic and thus do not allow aqueous liquids to be sucked in or transported. On the other hand, conventional adhesives which have pronounced hydrophilic properties are often poor adhesives.

### SUMMARY OF THE INVENTION

It is against the above background that embodiments of the present invention enable at least some disadvantages of the prior art to be eliminated. For example, in one embodiment, an adhesive foil comprising a carrier foil coated with an adhesive mixture comprising an acrylic adhesive and a detergent is disclosed. In another embodiment, a test element comprising the adhesive foil is also disclosed. The adhesive foil is useful as a hydrophilic adhesive cover for covering fluidic devices, such as a fluidic test element as described herein.

The embodiments of the present invention are further described by the attached figure and the following examples.

### BRIEF DESCRIPTION OF THE DRAWINGS

FIG. 1 is a perspective view of a test element with fluidic structures for use with a foil provided with an adhesive mixture described herein.

### DETAILED DESCRIPTION

According to embodiments of the present invention an adhesive mixture is provided which combines two desired properties, i.e. hydrophilicity and adhesiveness with one another. The combination of properties is a result of two components, i.e. the use of an acrylic adhesive plus the addition of a detergent.

The adhesive mixture also meets other important criteria for it's intended applications discussed hereafter in later sections. For example, the selected additive is a detergent that dissolves well in the acrylic adhesive. Additionally, the detergent provided in preferred concentrations makes the adhesive mixture hydrophilic while still retaining a desired adhesiveness. Also, the addition of the detergent in the acrylic adhesive does not result in blood haemolysis especially in the preferred concentrations stated herein.

It is to be appreciated that the detergent added to the acrylic adhesive does not soften or dissolve the adhesive even in combination with water or a sample. The addition of the detergent makes the adhesive mixture permanently hydrophilic and does not merely result in a short-term effect. The adhesive mixture itself can be prepared as a transparent material and does not itself have any or only a very low self fluorescence. The use of detergent and acrylic adhesive enables an adhesive mixture to be prepared which is free of solvents and in particular organic solvents as well as softeners. Finally, the adhesive mixture is heat-resistant. In summary, the adhesive mixture has a whole series of advantages and is in particular outstandingly suitable as an adhesive for adhesive foils for covers of fluidic devices.

The acrylic adhesive is an adhesive containing acrylic acid in one embodiment, and an acrylic acid-based copolymer in dispersion in another embodiment. The solids content in one embodiment is at least 40% by weight, in another embodiment at least 50% by weight, in still another embodiment at least 52% by weight, and in still yet another embodiment at least 53.5% by weight, and up to 65% by weight in one embodiment, up to 60% by weight in another embodiment, up to 58% in still another embodiment, and up to 56.5% by weight in still yet another embodiment.

The viscosity (at 25° C. and 50 rpm) is between 100 mPas and 500 mPas in one embodiment, and between 200 and 350 mPas in another embodiment.

The pH of the acrylic adhesive, and in particular of the dispersion comprising an acrylic acid-based copolymer, is between 2 and 7 in one embodiment, and between 3.5 and 5.5 in another embodiment.

Suitable acrylic acid-based copolymers are in particular copolymers based on acrylic acid monomers and optionally additional monomers e.g. ethylenically unsaturated monomers, preferably styrene, ethylene, propylene, butylene, butadiene, hexene or hexadiene.

The acrylic acid-based copolymer has at least one monomer of the formula (I):

CH₂═CH (R¹)(COOR²) (I),

in which R¹═H or C₁-C₁₀ alkyl, in particular methyl and R²═H or C₁-C₃₀ alkyl, preferably C₁-C₁₀ alkyl and in particular C₁-C₄ alkyl. Such monomers are also referred to as acrylic acid, methacrylic acid, acrylic acid esters or methacrylic acid esters. In one embodiment, the acrylic acid esters are methyl, ethyl, butyl, i-butyl and 2-ethylhexyl acrylates. In another embodiment, the methacrylic acid esters (in which R¹=methyl) are methyl-, ethyl-, butyl-, i-butyl- and 2-hydroxyethyl methacrylates.

In one embodiment, at least 50% by weight and up to 100% by weight of the acrylic acid-based copolymer is formed from monomers of formula (I). In another embodiment, at least 80% by weight and up to 90% by weight of the acrylic acid-based copolymer is formed from monomers of formula (I). In still another embodiment, about 85% by weight of the acrylic acid-based copolymer is formed from monomers of formula (I).

Whereas according to an embodiment of the invention it is possible that the acrylic acid-based copolymer is exclusively formed from monomers of formula (I), other monomers may also be present in other embodiments. Ethylenically unsaturated comonomers and in particular olefinically unsaturated monomers which contain at least one functional group are provided in preferred embodiments. Examples of such monomers are vinyl esters, vinyl halogens, vinylidene halogens, vinyl compounds with aromatic rings or heterocycles such as in particular vinyl acetate, vinyl formamide, vinyl pyrridine, ethylvinyl ether, vinyl chloride, vinylidene chloride or acetonitrile. Preferred functional groups which the olefinically unsaturated monomers contain, are for example hydroxyl, carboxyl, epoxy, acid amide, isocyanate or amino groups. The weight percentage of monomers of formula (I) in such copolymers is preferably ≧50% in one embodiment, and ≧70% in other embodiments.

As mentioned previously above, the adhesive mixture contains a detergent. The detergent has the effect that the adhesive mixture is overall hydrophilic and thus enables a transport of aqueous liquids in capillaries. In one embodiment, the detergent is contained in the adhesive mixture in an amount of about 1 to about 10% by weight, in another embodiment in the amount of about 1.5 to about 6% by weight, in still another embodiment in the amount of about 2 to about 4% by weight, and in still yet another embodiment in the amount of about 2.5 to about 3% by weight, based on the solids content of the acrylic adhesive.

A non-ionic detergent in one embodiment is used as the detergent. In other embodiments, N-D-gluco-N-methyl alkanamides which for example contain alkane chains with 4 to 20 C atoms may also be used as the detergent. In one particular embodiment, Octanoyl-N-methyl glucamide (C₁₅H₃₁NO₆) was used in which particularly good results were obtained. The detergent octanoyl-N-methylglucamide is also referred to as Mega 8. Mega 8 has no absorption at 280 nm and does not result in protein denaturation.

As described herein the adhesive mixture according to the invention is provided especially for use with test elements in one embodiment. It is, however, not limited thereto and can be used advantageously in all cases where both high hydrophilicity and good adhesiveness of an adhesive mixture are desirable or advantageous.

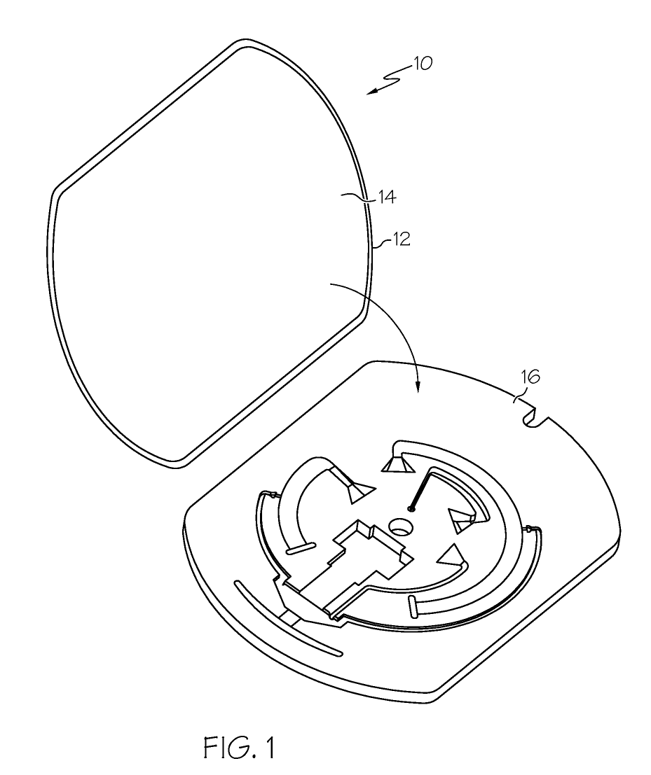

As shown by FIG. 1, a further embodiment of the present invention is an adhesive foil 10 comprising a carrier foil 12 on which the inventive adhesive mixture described previously above is applied, and enumerated by reference symbol 14. The invention therefore also concerns a carrier foil coated with an adhesive mixture. By applying the adhesive mixture 14 to the carrier foil 12, the adhesive foil 10 which is formed can, for example, be used advantageously to glue test elements or to cover test elements, such as test element 16. An advantage of this is that the adhesive mixture 14 also exhibits strong hydrophilic properties in addition to adhesive properties. When the adhesive mixture 14 is used in the adhesive foil 10 as a cover for fluidic devices, such as test element 16, this profile of properties i.e. adhesive as well as hydrophilic properties guarantees, on the one hand, a permanent leak-tightness and final covering and, on the other hand, ensures that for example sample, washing or rinsing solutions automatically flow into the device.

Basically all smooth, non-absorbent foils can be used as the material for the cover foil. The carrier foil 12 is preferably a plastic foil for example a foil made of polyester, polyethylene, polypropylene, polyvinyl chloride or polyethylene terephthalate. It is also possible to use a metal foil as the carrier foil 12 for example a gold or silver foil. The adhesive mixture 14 according to the invention is preferably applied to the carrier foil 12 in such an amount that the thickness of the dry layer is at least 5 μm, more preferably at least 10 μm and preferably at least 15 μm and up to 500 μm, in particular up to 100 μm, preferably up to 50 μm and particularly preferably up to 20 μm.

The carrier foil 12 itself preferably has a thickness of between 100 μm and 1 mm in one embodiment, between 200 and 300 μm in another embodiment, and in one particular embodiment about 250 μm.

The adhesive mixture 14 can be applied to the carrier foil 12 by means of known processes, for example, by means of knife-coating methods.

According to another embodiment of the invention it is also possible to provide the adhesive foil 10 on a protective liner, such as for storage. In this manner, the adhesive foil 10 consisting of the carrier foil 12 and the adhesive mixture 14 can then be taken off from the protective liner and applied onto the test element 16 as a cover. In one embodiment, the protective liner is made of polypropylene in a layer thickness of about 10 to about 50 μm in one embodiment, and in a particular embodiment, a layer thickness of about 30 μm. It is basically possible to use any protective liner materials but care should be taken that the protective liner does not release any hydrophobic materials onto the adhesive layer 14. For this reason protective liners which are provided with a silicone layer are less preferred.

In principle, the test element 16 according to various embodiments of the invention can be any test element. In one embodiment, the test t element 16 is a diagnostic test element and in one particular embodiment a test element with dry reagents (dry chemistry test element). In one preferred embodiment, the test element 16 is a test element with fluidic structures (also referred to herein as a fluidic test element or fluidic device), where liquid flows can be conducted through the fluidic structures of the test elements. The test elements according to the various embodiments of the invention can for example be used to determine glucose, cholesterol, proteins, ketones, phenylalanine and enzymes in biological fluids such as blood, saliva or urine. The test element 16 in one embodiment is preferably a disk-shaped test element such as described, for example, in US 2004/0265171 A1, the disclosure of which is herein incorporated fully by reference. Corresponding analytical systems are known, for example, from U.S. Pat. No. 4,456,581, U.S. Pat. No. 4,580,896, U.S. Pat. No. 4,814,144 or EP 1 077 771 B1. In this case and in one particular embodiment, the adhesive mixture according to the invention is used especially in the form of an adhesive foil to cover the test element. The adhesive cover according to the invention can be used universally for covering irrespective of design differences or design changes of test elements.

In a particularly preferred embodiment the test element 16 is an SID device as described for example in EP 1 795 894 A1, the disclosure of which is herein incorporated fully by reference. An example of the preparation of an SID device according to an embodiment of the present invention is provided hereafter.

### EXAMPLE 1

### Preparation of an SID Device

An adhesive mixture (Ucecryl WB 3171 adhesive) comprising an acrylic acid-based copolymer to which the detergent Mega 8 had been added was applied by a knife coating method to a plastic carrier foil of 250 μm thickness and dried for 8 minutes at 110° C. The thickness of the dry layer of the adhesive mixture was about 15 μm. The plastic carrier foil with the applied adhesive mixture was subsequently provided with a protective liner.

An accurately fitting cover was cut out of the adhesive foil with the aid of a cutting plotter for use in the SID device and glued onto the device. Function tests showed that a blood sample flowed automatically into the device.

The hydrophilic property of the adhesive coated on the carrier foil was determined by measuring the contact angle. The contact angle is in a range of 16 to 34° for concentrations of the detergent Mega 8 of 2% by weight to 4% by weight based on the solids content of the adhesive.

Although the various embodiments of the present invention have been described using specific terms, such description is for illustrative purposes only, and it is to be understood that changes and variations may be made without departing from the spirit or scope of the following claims.

What is claimed is:

1. An adhesive foil comprising a carrier foil coated with an adhesive mixture comprising an acrylic adhesive and a detergent.

2. The adhesive foil according to claim 1, wherein a dry layer thickness of the adhesive mixture on the carrier layer foil is in a range from about 5 to about 50 μm.

3. The adhesive foil according to claim 1, wherein the carrier foil consists of a material selected from plastic, polyester, polyethylene, polypropylene, polyvinyl chloride, polyethylene terephthalate, a metal, a gold foil, and a silver foil.

4. The adhesive foil according to claim 2, wherein the carrier foil consists of a material selected from plastic, polyester, polyethylene, polypropylene, polyvinyl chloride, polyethylene terephthalate, a metal, a gold foil, and a silver foil.

5. The adhesive foil according to claim 1, wherein the detergent is octanoyl-N-methylglucamide.

6. The adhesive foil according to claim 1, wherein the detergent is contained in the adhesive mixture in an amount of 2% by weight to 4% by weight based on the solids content of the acrylic adhesive.

7. The adhesive foil according to claim 5, wherein the detergent is contained in the adhesive mixture in an amount of 2% by weight to 4% by weight based on the solids content of the acrylic adhesive.

8. The adhesive foil according to claim 1, wherein the acrylic adhesive is a dispersion of an acrylic acid-based copolymer.

9. The adhesive foil according to claim 6, wherein the acrylic adhesive is a dispersion of an acrylic acid-based copolymer.

10. The adhesive foil according to claim 8, wherein the dispersion has a solids content of 40 to 65% by weight.

11. The adhesive foil according to claim 9, wherein the dispersion has a solids content of 40 to 65% by weight.

12. The adhesive foil according to claim 1, wherein the acrylic adhesive is an acrylic acid-based copolymer formed from at least one of the monomers of formula (I):
CH₂═CH(R¹)(COOR²) (I),
in which R¹═H or C₁-C₁₀ alkyl, and R²═H or C₁-C₃₀ alkyl.

13. The adhesive foil according to claim 11, wherein the acrylic adhesive is an acrylic acid-based copolymer formed from at least one of the monomers of formula (I):
CH₂═CH(R¹)(COOR²) (I),
in which R¹═H or C₁-C₁₀ alkyl, and R²═H or C₁-C₃₀ alkyl.

14. The adhesive foil according to claim 12, wherein the acrylic acid-based copolymer has at least one of the following monomers: acrylic acid, an acrylic acid ester selected from methyl, ethyl, butyl, i-butyl and 2-ethylhexyl acrylate, methacrylic acid or/and a methacrylic acid ester selected from methyl, ethyl, butyl, i-butyl and 2-hydroxyethyl methacrylates.

15. The adhesive foil according to claim 13, wherein the acrylic acid-based copolymer has at least one of the following monomers: acrylic acid, an acrylic acid ester selected from methyl, ethyl, butyl, i-butyl and 2-ethylhexyl acrylate, methacrylic acid or/and a methacrylic acid ester selected from methyl, ethyl, butyl, i-butyl and 2-hydroxyethyl methacrylates.

16. A test element comprising the adhesive foil according to claim 1.

17. A test element comprising the adhesive foil according to claim 2.

18. A test element comprising the adhesive foil according to claim 3.

19. A test element comprising the adhesive foil according to claim 4.

20. A test element comprising the adhesive foil according to claim 5.

21. A test element comprising the adhesive foil according to claim 6.

22. A test element comprising the adhesive foil according to claim 7.

23. A test element comprising the adhesive foil according to claim 8.

24. A test element comprising the adhesive foil according to claim 9.

25. A test element comprising the adhesive foil according to claim 10.

26. A test element comprising the adhesive foil according to claim 11.

27. A test element comprising the adhesive foil according to claim 12.

28. A test element comprising the adhesive foil according to claim 13.

29. A test element comprising the adhesive foil according to claim 14.

30. A test element comprising the adhesive foil according to claim 15.

31. The test element according to claim 16, wherein the test element has fluidic structures.

32. The test element according to claim 16, wherein the detergent acts as a cover to the test element.
